(19) United States
(12) Patent Application Publication
(10) Pub. No.: US 2019/0370858 A1
(43) Pub. Date: Dec. 5, 2019

(54) PURCHASE TRANSACTION BASED ADVERTISING SYSTEM

(71) Applicant: Enpulz, LLC, Austin, TX (US)

(72) Inventors: James Duane Bennett, Hroznetin (CZ); Bindu Rama Rao, Laguna Niguel, CA (US)

(73) Assignee: Enpulz, LLC, Austin, TX (US)

(21) Appl. No.: 16/000,017

(22) Filed: Jun. 5, 2018

(51) Int. Cl. G06Q 30/02; G06Q 20/32

(52) U.S. Cl. CPC G06Q 30/0251; H04W 4/025; G06Q 20/3224

(57) ABSTRACT

A token based self-managed advertisement and promotion infrastructure supporting self-managed advertisements associated with pre, post and mid purchase transactions. The infrastructure stores user info that includes user profile, GPS info, purchase transaction records, payment mode and mode details for future use. The infrastructure delivers advertisements and promotions to the user, any time prior to the actual purchase (pre-purchase transaction), at the time of purchase (mid-purchase transaction) and after the purchase (post-purchase transaction). The sellers or merchants are able to filter and target individual users or a group of users to deliver ads and promotions. The users, on the contrary, are able to self-manage their ads and promotions, by choosing and picking specific sellers, merchants and the area of interest.

### BACKGROUND

### 1. Technical Field

The present invention relates generally to secure financial transactions, and, more specifically, to providing advertisements during mobile phone-based sales transactions and fund transfers to a customer using cards, mobile devices and computers with merchant web sites and point of sale terminals based on account tokenization.

### 2. Related Art

Several types of bank cards and credit cards exist today that people use for purchasing goods and services, online and at stores. With some of these cards, card information can be stored in the phone and exchanged with a merchant terminal to carry out a transaction. In others, tokens that represent card information can be stored instead of the actual card information. Interfacing with a merchant system may be based on contact, tethered, near contact (short range wireless), or via Internet connectivity. Mobile devices such as phones and even cards can be designed and configured to interface in any one or more of such ways.

Token use offers security as tokens do not reveal the underlying account information. For added security, tokens can be configured to carry many types of usage restrictions. For example, tokens may be configured to only be used with a current merchant, have a one-time use, or be valid only for a week.

Transaction communications, i.e., tokens plus cryptograms that encode purchase transaction data, are passed by a user's card, computer, or mobile device through a merchant system toward an issuer's system for processing. Along the way, a token service provider swaps out the token with the user's primary account number (PAN). In this way, the user can rest assured that their PAN is only exposed via secure linkages between the token service provider and the issuer. The issuer's system uses the PAN to access the account information via an issuer's database look up. For example, mobile wallet solutions such as Apple Pay and Google Wallet take advantage of this kind of tokenization.

To carry out secure tokenization, secure elements (SE) are located in secure hardware, e.g., within Near Field Communication (NFC) circuitry associated with a card, mobile device or computer or in a cloud-based support service or on some other particular supporting server. Secure elements are often employed inside an NFC based credit card or mobile device, and stores tokens and cryptogram keys, that are used during sales transactions. The SE within a mobile device provides a tamper-proof environment that supports a customer interaction with and through a merchant system to carry out an end to end secure payment transaction wherein moneys are moved between the customer's credit or bank account to an account of the merchant.

Further limitations and disadvantages of conventional and traditional approaches will become apparent to one of ordinary skill in the art through comparison of such systems with the present invention.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

FIG. 1 is a block diagram illustrating a token based self-managed advertisement infrastructure 105 supporting self-managed advertisements associated with pre, post and mid purchase transactions in accordance with the present invention;

FIG. 2 is a schematic diagram illustrating the user payment device of the FIG. 1, as an example;

FIG. 3 is a schematic diagram depicting the user payment device of the FIG. 1, wherein the user device receives self-managed ads and promotions in a variety of ways;

FIG. 4 is a schematic diagram illustrating the user payment device of the FIG. 1, as an example; wherein the user payment device is a near field communication device;

FIG. 5 is a schematic diagram illustrating the seller system or merchant system of FIG. 1, in accordance with the present invention;

FIG. 6 is a schematic diagram illustrating the TCCM server architecture, in accordance with the present invention;

FIG. 7a is a schematic diagram illustrating self-managed advertisements associated with pre-purchase transactions, in accordance with the present invention;

FIG. 7b is a schematic diagram illustrating self-managed advertisements associated with post-purchase transactions, in accordance with the present invention;

FIG. 8 is a schematic diagram illustrating self-managed advertisements associated with mid-purchase transactions, in accordance with the present invention; and

FIG. 9 is a schematic diagram illustrating the processes involved in self-management by the user payment device.

### DETAILED DESCRIPTION OF THE DRAWINGS

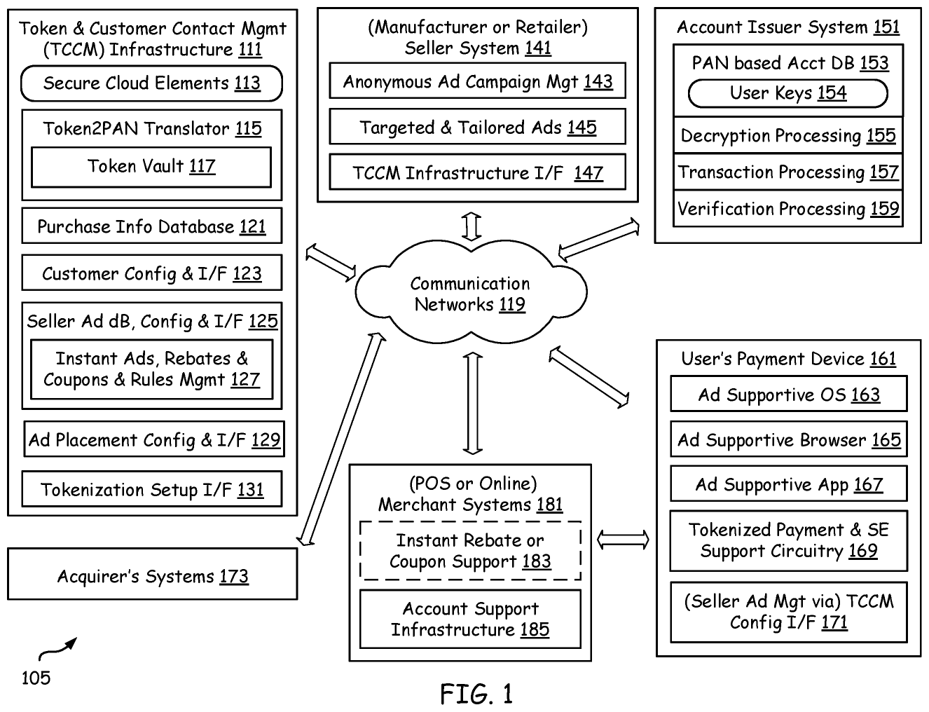

FIG. 1 is a block diagram illustrating a token based self-managed advertisement infrastructure 105 supporting self-managed advertisements associated with pre, post and mid purchase transactions in accordance with the present invention. Within the token based self-managed advertisement infrastructure 105, a user (customer or buyer, in specific), using a user's payment device 161, conducts a purchase transaction. The user's payment device 161 may be a contact card or contactless (credit card, debit card, near field communication device and such), mobile device, personal computer or laptop, or any such other device that can be configured to carry out a purchase transaction.

In particular, the user's payment device 161 interacts with merchant systems 181 (which may involve one or more merchant devices) to initiate the purchase transaction. The merchant systems 181 may support an online store, a physical store (music related shop, restaurant, general stores and such) in a mall or independent store on a familiar or unfamiliar locality, and so forth. If supporting a physical store, the merchant systems 181 may comprise at least a Point of Sale (POS) terminal which is capable of magnetic stripe reading, card information manual entry, near contact exchanges, and contact-based exchanges. That is, if the user (i.e., the customer or buyer) attempts a purchase transaction in a physical store, such transaction will often begin with an interaction between the user's payment device 161 and the merchant systems 181 where a communication exchange leads to a delivery of a token and cryptogram from the user's payment device 161 to the merchant systems 181.

The merchant systems 181 may have access to a history of user's purchases and thereby may be able to determine user preferences or purchase habits and even accelerate purchases via acceptance of repurchase and refill settings. Depending on the configuration of the merchant systems 181, such history, presets and preferences may be stored in whole or in part locally within the merchant systems 181 or in whole or in part remotely within one or more of the user's payment device 161, acquirer's systems 173, seller system 141, TCCM (Token & Customer Contact Management) infrastructure 111, and account issuer system 151.

The TCCM infrastructure 111 consists of: secure cloud elements 113; token to PAN translator 115 which includes a token vault 117; purchase information database 121, customer/buyer interface 123 through which a user can manage advertisers, advertisements and their overall configuration; seller interface 125 which includes an ad database and supports seller ad submissions, targeting and configuration; and tokenization setup interface 131. The user's payment device consists of an ad supportive OS (Operating System) 163, ad supportive browser 165, ad supportive app 167, tokenized payment & SE support circuitry 169, and TCCM configuration interface 171.

The account issuer system 151 consists of PAN based account database 153, decryption processing 155, transaction processing 157 and verification processing 159. Herein, communication networks 119 may comprise one or more of Internet, wired or wireless communication networks, and wired or wireless point to point links. The communication networks 119 may consist of one or more of proprietary or industry standard architectures and elements.

Generally speaking, the tokenization involves sending a reference code that cannot be reversed in the absence of a tokenization system. It conceals the primary account number (PAN) from being exposed to misuses (any unwanted or unintended activities) within the communication network 119. The tokens may be temporary in nature with expiry dates or may be more permanent.

The tokenized payment and SE (Secure Element) support circuitry 169 contains the above said token (generated by using random numbers, for example). The circumstances involved in storing the tokens in the tokenized payment and SE (Secure Element) support circuitry 169 may include powered up or down, contact or contactless cards, radio frequency communication devices or online or offline instances. In cases of contact or contactless cards, for example, a chip embedded within the card (in the user's payment device 161) makes this possible.

These tokens and their corresponding PAN are also securely stored in the token vault 117, to be able to detokenize by the token to PAN translation unit 115, once token's job of concealing the PAN (in general, any data that is to be securely transmitted via the communication network 119) is accomplished. In cloud-based secure elements, the secure element can be cloud or user's payment device 161 or both—for each and every issuer/account that a user owns. The tokenization setup 131 allows software or service interactions with the user, to allow tokenization happen.

In addition to the tokenization, public and private key based encryption and decryption (E2EE—End to End Encryption) are also employed. This also utilizes the secure cloud elements 113. In addition, private cryptography and associated keys (issuer master key for breaking and payment device keys for encrypting) are preloaded in the user's payment device 161 through interaction with or during manufacturing or provisioning by the issuer. In accordance with the present invention, the seller system 141 may belong to a manufacturer, distributor or retailer, serving a large community of the merchant systems 181. The seller system 141 has access to the merchant systems 181 and the user's payment device 161. This allows the seller system 141 to place ads in the merchant systems 181 and/or the user's payment device 161. The seller system 141 consists of anonymous ad campaign management 143, targeted and tailored ads 145 and TCCM infrastructure interface 147. The merchant systems 181 consists of account support infrastructure 185 and instant rebate or coupon support 183. The merchant systems 181, on the contrary, may belong to everyday shop keepers. Alternatively, they may also belong to online store keepers.

The user (buyer or customer) interacts to carry out a purchase transaction which involves the token use along with an accompanying cryptogram (which has transaction and token restriction information therein). More importantly, once the token and crypto setup is complete, the user may decide to buy something. In accordance with the current invention, the user interaction involves: (a) receiving promotions before a transaction initiation (pre-transaction advertising); (b) during the transaction, with add on ad offers (mid-transaction advertising); and (c) receiving ads after the transaction (post-transaction advertising).

The ads and promotions may include loyalty building ads (such as come back and use a particular discount), cross selling (such as buy something more now offers) and (c) up selling (do not buy that, buy this instead now). In cases of cross selling and up selling, the secondary item or secondary purchase or replaced purchase can take place online. For example, the user goes to buy a TV and when at the counter, an ad pops up on the user's payment device 161 that says, “We can ship from online transaction completion for delivery in two days unless you want to carry out now” and where the transaction of the former is at a different retailer than the current retailer.

Specifically, the manufacturers, distributors or retailers, via the seller system 141, may wish to influence the POS and online store keepers, by utilizing merchant systems 181 and the user's payment devices 161, respectively. This, in order to increase the sales of their products. In another embodiment, the POS and online store keepers, via merchant systems 181, may wish to influence the users, by utilizing their user's payment devices 161. The current invention, as shown in the token based self-managed advertisement infrastructure 105, makes this possible in a variety of ways.

The TCCM infrastructure 111 captures transaction information regarding actual products purchased at actual merchants by a particular user. Thereafter, that information can be used by sellers to place promotions and ads on the user's payment device 161, computers, and so forth. This means a seller loads an ad, then places filters and rules, based on the rules placed in instant ads, rebates and coupons and rules management 127 and purchase transactions stored in the purchase information database 121.

For example, users with transactions (at a coffee shop) twenty times in the past year but zero times in the past months may be able to buy a coffee for free. In this case, the promotion and ads are generated based on rules and transaction flow alone, and with no other customer information or details needed.

To address privacy concerns, the users get full control of locking and unlocking access and the degree of access that a seller may have in placing ads, by utilizing the TCCM configuration interface 171. In general, the following configurations are made available to the users: (a) They can release any personal info for their “profile” to be added to the TCCM infrastructure 111; (b) The TCCM infrastructure 111 can hide all these user profile, transaction history, etc., fully from the seller system 141; (c) They can allow their identify info (profile info, e.g., age, address, phone, email, etc.) be accessible on a seller by seller basis; (d) They can restrict ad types and sellers and degrees of contact (annoyance/desire) through the user interface.

The user's payment device 161 has an embedded GPS (global positioning system) system. This allows the seller system 141 or merchant systems 181 to place an instant advertisement, on the go, while they are in the vicinity of the stores or online stores, via merchant systems 181. For this, the seller system 141 and merchant systems 181 have targeted and tailored ads 145 and instant rebate or customer support 183.

For example, the user is a regular customer of a coffee shop chain. The user, upon being in the vicinity of the coffee shop, may receive a pre-transaction advertisement from the seller system 141 or merchant systems 181, via the TCCM infrastructure 111, that provides him or her instant coupons, rebates or free goods (for example, a free doughnut if 8 glasses of latte is purchased within a month).

In another example, the seller system 141 is a well-known newspaper publisher. While standing in queue and purchasing coffee in the coffee store, if he or she purchases today's newspaper or reads online that newspaper, a post transaction advertisement may popup in the user's payment device 161. This tells the user that a huge discount is possible, if he or she purchases the newspaper subscription right in there.

To make these types of advertisements possible, the user's payment device 161 consists of an ad supportive OS 163, ad supportive browser 165 and ad supportive app 167. For similar reasons, the seller system 141 or merchant systems 181, respectively, have anonymous ad campaign management 143 and instant rebate or coupon support 183, and the TCCM infrastructure 111 has seller ad database, configuration and interface 125 and the instant ads, rebates and coupons and rules management. 127.

Furthermore, these advertisements may be as simple as text messages to as complicated as interactive (and entire screen covering) standard advertisements. The advertisements may be general in nature or highly personalized. For example, if the user enters this particular region or locality (such as malls, stores, sports grounds and so forth), the TCCM infrastructure 111 may deliver a specific message tailored for him or her. For a specific example, if the user enters the mall (where a coffee shop chain is located and the user is a regular customer), the user's payment device 161 receives a message stating that “If you come to our coffee shop today and have a latte, you will receive a doughnut at half price.”

As mentioned above, these timely and instant advertisement generations and distributions maybe pre-transaction, mid-transaction and post-transaction types. For example, standing in queue for a latte, knowing what the user usually orders, an advertisement for brownie at half price may be offered. This is a pre-transaction advertisement. Similarly, a well-known newspaper publisher may offer a mid-transaction or post-transaction advertisement. For example (of mid-transaction or post-transaction advertisement), while purchasing the coffee or while having the coffee, respectively, an advertisement to purchase the newspaper (available at the counter) may popup.

The TCCM configuration interface 171 of user's payment device 161, in conjunction with the ad placement configuration & interface 129 of TCCM infrastructure 111, allow the user to manage the types of advertisements and the manufacturers in specific, to address the privacy concerns. For example, user who just bought a luxury car may wish to look through the ads that provide him or her only advertisement related to new car products and to specific manufacturers only. He or she may not wish to receive any other advertisements. A user who wishes to remain anonymous may not receive any advertisements at all, upon configuring the ad placement configuration and interface 129, via the user's TCCM configuration interface 171.

Finally, the TCCM infrastructure 111 also supports user and merchant ratings. The users are given provisions to rate the product purchased, wherein they get to do so only if they make purchases and can only rate based on what they buy or the merchant system 181 from which they bought. Also, customers can be rated so that ads can be more controlled. This avoids misuse of the token based self-managed advertisement infrastructure 105.

By utilizing user and merchant rating, a user or merchant who just visits quickly for click through events can be screened out. For example, if the user is paid for clicks, then high click volume users can be capped at a per month limit and/or screened out by the advertiser in their filtering ad setup. In addition, a user can screen advertisers to only allow very high-quality products to be advertised.

So, the user frequency of ad visits per month, user value (customer that buys often in response to ads—for the advertiser to consider) and advertiser annoyance level, advertiser trustworthiness and product quality (for the users to consider) may all come into play in the token based self-managed advertisement infrastructure 105 (via ratings of different types). This is only possible if the TCCM infrastructure 111 stands in the middle of the transactions.

For example, according to one embodiment, a method is used by the advertising system 105 that is associated with a card-based transaction flow, the card-based transaction flow supporting the card issuer 151 via a token management infrastructure 111. The method comprises receiving, during an ongoing purchase transaction, transaction data from a point of sale 181 system of a first merchant, the transaction data comprising purchased product data, merchant identification data, and a token representing a card of a buyer, the transaction data being generated based on the ongoing purchase transaction that is established between the point of sale system 181 and a phone device 161 of the buyer, the phone device 161 having a secure element 169 containing card data corresponding to the card of the buyer. The method also comprises analyzing, during the ongoing purchase transaction, at least a portion of the transaction data and identifying, based on the analysis, advertisement data, the advertisement data corresponding to at least one offer from one of a plurality of second merchants. It also comprises delivering, during the ongoing purchase transaction, the advertisement data to the phone device 161 of the buyer for presentation to the buyer. The card-based transaction flow is credit card-based in one configuration, debit card-based in another configuration and prepaid card (such as gift cards) based in a different configuration. A combination of these modes in a single configuration is also contemplated.

In a related embodiment, the method further comprises receiving and storing the advertisement data in advance of the ongoing purchase transaction. For example, the advertisement is provided by the retailer seller system 141 based on what the user is currently purchasing (for example factoring the items being purchased, optionally factoring the time of the day the items are being purchased and other correlated items not being purchased at that time).

In a related embodiment, the operation of receiving comprises receiving the transaction data from the point of sale system 181 of the first merchant during the card-based transaction flow associated with the ongoing purchase transaction. Thus, the receiving comprises receiving the transaction data from the card-based transaction flow, the receiving occurring during the associated ongoing purchase transaction.

In yet another related embodiment the presentation of the advertisement data to the buyer occurs on the phone device 161 during the ongoing purchase transaction. For example, before the current purchase transaction is completed, the buyer is presented with one or more advertisement data, for products related to the currently purchased products, for products that are complementary to the purchased products, or products that the user had previously purchased along with the currently purchased products. The phone device 161 is a smartphone with downloadable apps in one configuration, a tablet device such as iPad in another configuration, and a generic VIOP technology-based device in a different configuration. The use of other types of handheld devices is also contemplated.

In yet another related embodiment the advertisement data comprises an offer at a second premises of the one of the plurality of second merchants.

In another embodiment, the phone device 161 supports management of advertising by the buyer. For example, the buyer may set preferences of the type of advertisements that are allowed. Such preferences comprise favorite businesses, favorite cuisine types, favorite stores, favorite groceries, favorite banks, favorite entertainment places, favorite bars etc.

In a different embodiment, the advertising system 105 is associated with a card-based transaction flow, the card-based transaction flow supporting a card issuer via a token management infrastructure 111. The advertising system 105 comprises an advertising database 125, 145 configured to store a plurality of advertisements of a plurality of other merchants. The advertising system 105 also comprises a communication interface circuitry 691 configured to receive card-based transaction data generated during a purchase transaction between the point of sale system 181 of a merchant and a phone device 161 of the buyer, the phone device 161(another such phone device is user device 301) of the buyer having a secure element 169 containing card data corresponding to a card of the buyer. The advertising system 105 further comprises processing circuitry 693 (for example, described as processing circuitry 693 of the TCCM server architecture 607) configured to select from the advertising database one of the plurality of advertisements of one of the plurality of other merchants, the one of the plurality of other merchants operating independently of the merchant, the processing circuitry 693 being configured to direct the one of the plurality of advertisements to the phone device 161 of the buyer for presentation to the buyer during the purchase transaction. Thus, the phone device 161 (and in general, the user's payment device 161) receives advertisements in the midst of a current sales transaction being conducted by the buyer with a merchant who is using the POS (or online) merchant systems 181. The token & customer contact management infrastructure (TCCM) 111 processes the token and cryptograms received as part of the sales transaction, and before the sales transaction is completed, uses the opportunity presented to search, retrieve and present to the buyer on the buyer's phone device 161 one or more advertisements for perusal.

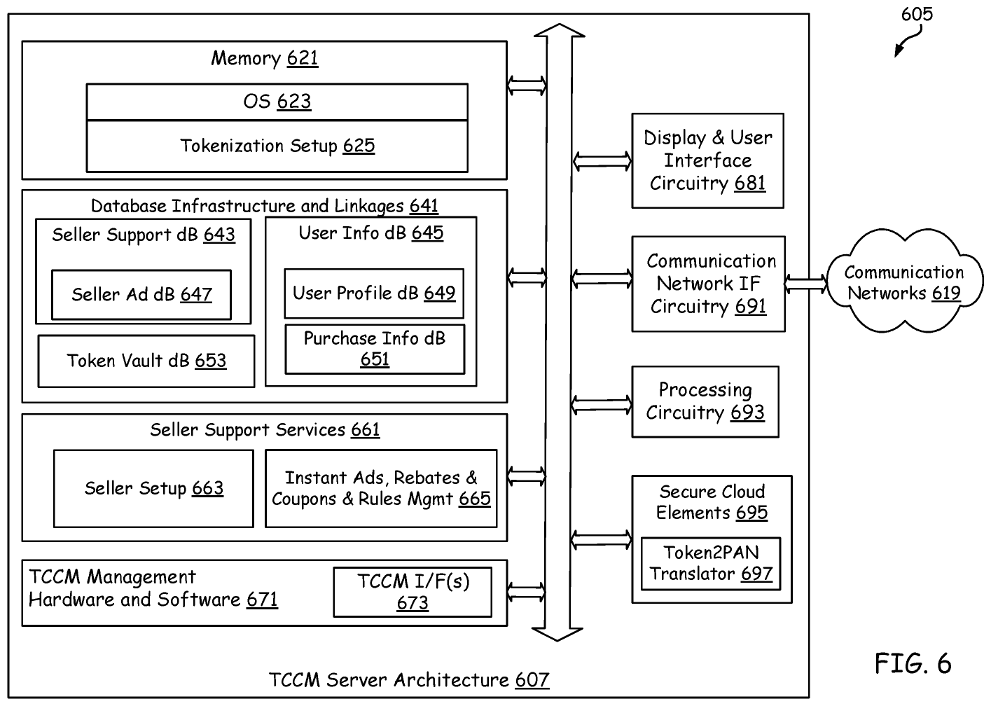

The advertising database, for example, is made available as a seller advertising database, config & interface 125 in the TCCM 111. It is also made available selectively as the purchase information database 121 of the TCCM 111, and as the targeted & tailored ads database 145 of a seller system 141. Additional details of the database infrastructure and linkages 641 are provided ahead in description of FIG. 6.

In a related embodiment of the advertising system 105, the one of the plurality of advertisements of the one of the plurality of other merchants comprises an offer for the buyer to visit a second premises to conduct a subsequent purchase transaction for a second item. For example, during the purchase of a full tank of gas at a gas station via the merchant system 181 early in the morning, the buyer using the phone device 161 is prompted to purchase coffee at a Starbucks next door to the gas station. This prompting being an advertisement being delivered from the seller ad database 125. Such advertisement may include coupon, rebates, and pricing information to entice the buyer to make the Starbucks visit. Moreover, the Starbucks advertisement, for example, is selected based transaction related data exchanged to carry out the purchase transaction at the gas station via the merchant system 181. Starbucks may store a rule set within the management system 127 such that only a purchase of gasoline at the local gas station triggers the ad delivery. Many other trigger rules could be included, such as purchase amount, item identification, merchant restrictions, time of day, day of week, date, number of ad placements per unit time or total, only for a particular card issuer (or card type or status), only after a certain number of repeat purchases nearby, GPS (Global Positioning System) or other locating system range, home address of the buyer, gender, age, and so on. All merchants can place such restrictions as well along with their tailored advertisements with the Seller advertising database and management 125 and 127.

In a related embodiment of the advertising system 105, the receipt of the card-based transaction data by the communication interface 691 occurs from a transaction communication flow between the merchant system 181, token management system 111 and card issuer system 151.

In another related embodiment, the advertising system 105 further comprises a buyer interface called customer config & interface 123 configured to allow a buyer to manage their advertising settings.

In another related embodiment, the advertising system 105 further comprises a second communication interface. For example, it uses text messages to interact with the phone device 161, and seller Advertising database, config & interface 125 to make it possible for sellers using the seller system 141 to upload/add one or more advertisements for selective dissemination.

In another related embodiment, the second communication interface is configured to interact with the phone device 161 during the purchase transaction in a communication pathway that is independent of the merchant system 181. For example, if the advertisement system 105 uses TCP/IP protocols to interact with the merchant systems 181, it can use a text message service (or a different cellular protocol/network) to interact with the phone device 161.

In another related embodiment of the advertising system 105, the one of the plurality of advertisements is delivered to the phone device 161 via the second communication interface. Thus, the interactions with the merchant system 181 occurs over a first interface (such as the tokenization setup interface 131) while the interactions with the phone device 161 for delivery of advertisement(s) during the sales transaction occurs via the second communication interface, such as the customer config & interface 123.

In a different embodiment, an advertising system 105 is associated with a card-based transaction flow, the card-based transaction flow supporting a card issuer via both a merchant system 181 located at a first premises and a token management infrastructure 111. The advertising system 105 comprises an advertiser interface 129 (also called Ad placement config & interface 129) for use by buyers in advance of purchase transaction wherein they can control the timing of delivery and presentation of purchase transaction advertisements on the device 161, i.e., before, during or after a purchase transaction. The buyer via the interface 129 can also specify types of advertisements to block or favor, including categories of offers, regional location restrictions of merchants, online or offline merchant restrictions, whether to employ anonymity, whether to withhold data categories of a buyer's transactions or transaction types, restrict access to data types in whole or in part, and so on. This allows a buyer to both control what types of transaction information is made available to the be used in ad placement which is based on a seller's rules. For example, a seller may require identification of a particular item class before triggering their ad placement. However, a buyer may choose to block access to their item transaction data. Thus, the seller's ad will never trigger. Likewise, a buyer may choose to block all ads from particular Sellers or types of sellers.

In a further example, the advertising system 105 can be configured to receive a plurality of advertising data from a plurality of advertisers, a first portion of the plurality of advertising data corresponding to an advertisement associated with a second premises (for example, a second merchant premises in proximity to the merchant in the first premises, such as a fast food joint in proximity to a gas station where a user is currently conducting a sales transaction). The advertising system also comprises an advertising database configured to store the advertising data and a communication interface circuitry configured to receive transaction data generated during a purchase transaction between a merchant system and a phone device of a buyer, the phone device having a secure element containing card data corresponding to a card of the buyer. The advertising system further includes a processing circuitry configured to select, based on the transaction data, from the advertising database the first portion of the plurality of advertising data, the processing circuitry being configured to direct the selected first portion of the plurality of advertising data to the phone device for presentation to the buyer.

The purchase transaction, in some embodiments may also involve a purchase of a first item from the merchant system of a first merchant, and the advertisement associated with the second premises comprises an offer relating to a second item of a second merchant located at the second premises, and the offer comprising a request for the buyer to visit the second premises to conduct a subsequent purchase transaction for the second item. In addition, the receipt of the transaction data by the communication interface may also occur from and during the exchange of the transaction data in a transaction flow between the merchant system, token management system and card issuer system (also called account issuer system).

The advertising system may also include a buyer interface configured to allow a buyer to manage their advertising settings. Such management will assist the buyer in restricting deliveries of future transaction related advertisements to those types of ads the buyer has interest in receiving and at times that the buyer prefers receipt to occur. Presentation of received ads can occur before, during and after a purchase transaction depending on such buyer configurations, and such ads being selected based on ongoing transactions using rule sets for placement established by each seller/advertiser placing a given ad. Thus, based on a current sales transaction at a first merchant, a buyer is provided with one or many advertisements that are triggered based on the current sales transaction data wherein these advertisements were posted by sellers/advertisers that are not the current merchant.

In some embodiments, the advertising database couples with a token management system. Therein, an anonymous ad campaign management system manages targeted and tailored ads. This system may also be coupled or included within a TCCM infrastructure.

The advertisement system, depending on the overall configuration, may also utilize a second communication interface to interact directly with a phone device during the purchase transaction. For example, the TCCM infrastructure may utilize a cellular pathway (e.g., for SMS/MMS messaging) to reach the phone device of the buyer without exposing the communication exchange data to the merchant system. Likewise, the second or a third communication interface can be utilized by a card issuer's system to conduct private and secure communication flow without having to pass underlying communication exchanges through the merchant terminal or the TCCM infrastructure. Particular Apps (applications) that support such direct interactions can be installed on the buyer's phone device. Alternatively, web browser-based interaction, SMS/MMS, and so on might flow through the cellular, WiFi, Bluetooth or any other wireless or wired network or communication pathway.

Based on purchase data flowing through the payment infrastructure of the advertising system, other merchants may be selectively informed of an opportunity to make a sale with the buyer of the current transaction. In addition, special treatment can be provided for a premium card. For example, a coffee shop next to a gas station where a buyer is conducting a sales transaction with the merchant system can send ads to the phone device of the buyer during a sales transaction that offers free coffee while the buyer waits, as he holds a premium card. Other such premium card benefit services are also contemplated. Note that such benefits and advertisement presentation in the midst of a sales transaction at a POS device is provided by the present invention for both durable token-based transactions or one-time use-based token-based transactions.

In one embodiment, the buyers are able to self-manage their ads and promotions, by choosing and picking specific sellers, merchants and the area of interest. Thus, during a sales transaction at a POS device, the buyer is presented with advertisements from other merchants based on the self-managed preferences, and the criteria they themselves have previously set/configured. Moreover, the current merchant at which a buyer is conducting a transaction may also benefit from such advertising functionality. Such merchant may load its own ads into the transaction-based advertising system of the present invention and set rules that trigger such ad during an ongoing purchase on such merchant's POS. This way, the merchant still has time to capture a further sale before leaving that merchant's premises.

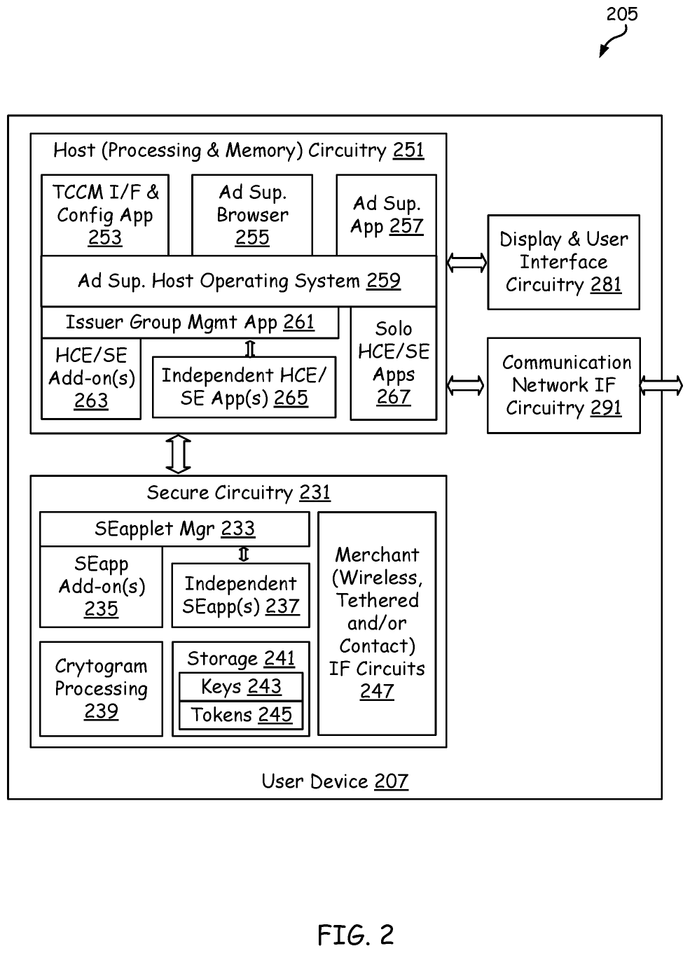

FIG. 2 is a schematic diagram illustrating the user payment device 205 of the FIG. 1, as an example. In this example, the user payment device 207 is at least a part of a mobile phone, computer or an independent payment device (specifically made for payments).

In this exemplary scheme, the user device 207 consists of host (processing and memory) circuitry 251, secure circuitry 231, display and user interface circuitry 281 and communication network interface circuitry 291. The user payment device 207 also consists of software elements to make up a complete device, in accordance with the present invention.

The host circuitry 251 consists of TCCM interface and configuration application 253, ad supporting browser 257, ad supporting host operating system 259, issuer group management application 261, host card emulation/secure elements (HCE/SE) add-on(s) 263, independent HCE/SE application(s) 265 and solo HCE/SE applications 267.

The user device 207, in one embodiment, works as an online payment device. In another embodiment, it works as an offline payment device. Even a nonworking (dead) user device 207 can be used to make payments, in a brick and mortar merchant's shop, for example. Similarly, even when the online payment is not possible (such as an unavailability of Internet), the user device 207 can be used to make payment. To make these embodiments possible, the host card emulation/secure elements (HCE/SE) add-on(s) 263, independent HCE/SE app(s) 265 and solo HCE/SE apps 267 are utilized.

The user device 207 also consists of secure circuitry 231, which in turn consists of secure element applet manager 233, secure element applet add-on(s) 235, independent secure element applications 237, cryptogram processing 239, storage 241 (keys 243 and tokens 245) and merchant (wired, tethered and/or contact) interface circuits 247.

The secure element applet manager 233 (secure circuitry 231, in general) makes cryptograms (encryption and decryption by using public and private keys) possible. On the contrary, ad supporting host operating system 259 (host circuitry 251, in general) makes tokenization possible. Also, note that even if there are ten different credit cards from a variety of issuers, for example, they can all be emulated by the user device 207, some of which by utilizing these modules (263, 265 and/or 267) while others by the secure element applet manager 233, secure element applet add-on(s) 235, independent secure element applications 237, cryptogram processing 239, storage 241. (They can also be by utilizing parts of both.)

In accordance with the current invention, the hardware circuitry and the software of host operating system 259, TCCM interface and configuration application 253, ad supporting browser 255 and ad supporting application 257 are utilized to deliver ads and promotions, via the tokenization and cryptogram channels, to the user. These advertisements and promotions may end up in one of many forms, such as visual message (screen saver space, web browser bottom, middle or the top parts, and so forth), text message, audio message etc. Generally speaking, the ads comprises of requesting the user to get acquainted or purchase the seller's or merchant's products and the promotions comprises of requesting the user to consider buying their products by providing discounts, coupons etc. The user is provided with options to select between ads and promotions or to have them both.

Finally, the user determines which types of ads and promotions he or she would like to see, by selecting them from a list (so as to not get overwhelmed by the ads). This list originates from the user's prior purchase transaction records. For example, the user may decide to not have any mid-transaction ads/promotions or pre-transaction ads/promotions but would only like to have post-transaction ads or promotions, based on her purchase transaction of a luxury car (such as car cleaning products, luxury seat covers or mats from few known merchants or sellers).

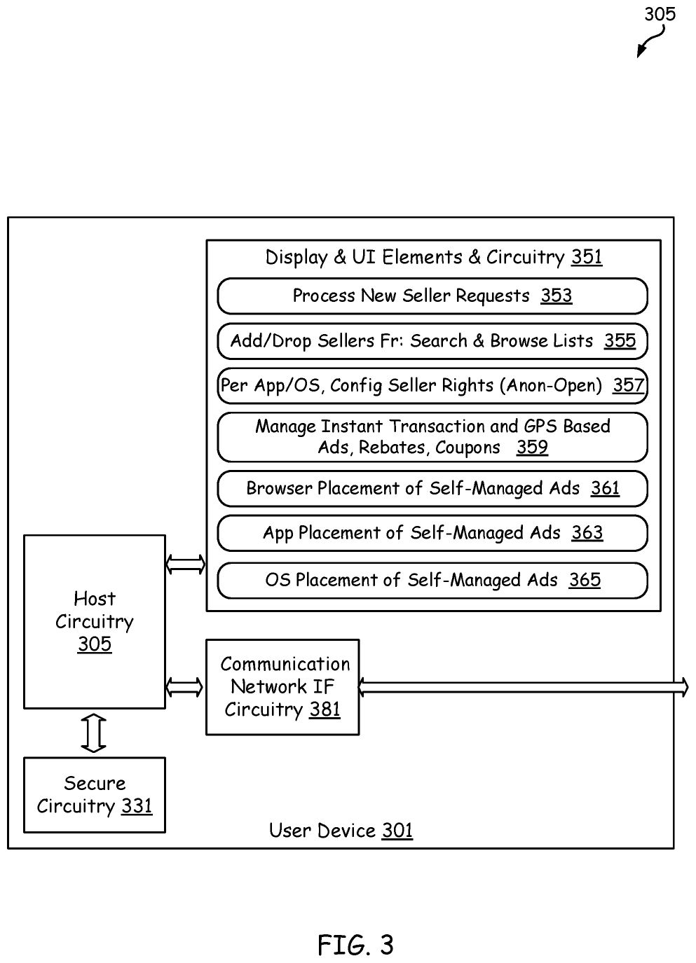

FIG. 3 is a schematic diagram depicting the user payment device 301 of the FIG. 1, wherein the user device receives self-managed ads and promotions in a variety of ways. Herein, the user of the user device 301 manages his or her own ads by opting to choose from a list (of a wide variety of sellers and merchants) and hence the term “self-managed.”

The user device 301 comprises of secure circuitry 331 (as detailed in the FIG. 2), communication network interface circuitry 381, host circuitry 305 (as detailed in the FIG. 2) and display and user interface (UI) elements and circuitry 351. The user interface elements and circuitry 351 may have the support for keyboard, display (such as ones found in the smart phones), speakers etc.

The user interface (UI) elements and circuitry 351, in turn, comprises of hardware and/or software elements of operating system (OS) placement of self-managed ads and promotions 365, application placement of self-managed ads and promotions 363 and browser placement of self-managed ads and promotions 361.

The OS placement of self-managed ads and promotions 365 provides the user an opportunity to opt to place ads and promotions on the screens, where the operating system dependent events are occurring. For example, in the spaces of screen savers, while logging into the user device 301 and so forth. These advertisements or promotions may occur while being in online or when the user device 301 is offline.

Similarly, the application placement of self-managed ads and promotions 363 allows the user to manage the ads and promotions in any of the apps. For example, in smart phones, there are plenty of empty screen places available where the user may opt to watch ads or promotions. For example, stock market quotes and other financial information along with advertisements of a stock broker, at the bottom of screen of a smart phone while running a finance related app. These advertisements or promotions may occur both online or offline. Furthermore, the browser placement of self-managed ads and promotions 361 allows the user to opt when and where the ads or promotions may appear on the screen, while the browser application is running.

The user interface (UI) elements and circuitry 351 also comprises of manage instant transaction and GPS based ads, rebates, coupons 359, per app/OS, configuration seller rights (anon-open) 357, add/drop seller fr: search and browse lists 355, and process new seller requests 353.

The manage instant transaction and GPS based ads, rebates, coupons 359 allows the user to manage instant pre-transaction and/or GPS triggered ads and promotions such as rebates and coupons. For example, the user entering a region of a movie or drama theater may receive a promotion, asking the user to visit the theater (providing the user with rebates), for an offseason show. This promotion is of pre-transaction type and is GPS triggered. The ad or promotion module 359 provides the user with an option to manage such triggers.

The per app/OS, configuration seller rights 357 provides the user a per application, per operating system and per browser right configuration. The add/drop seller 355 provides the user with an option to add or drop the sellers or merchants from the lists, by selecting them by searching and browsing. The process new seller requests 353 allows the user to configure the rights to a new seller. For example, the seller, while transacting with the user for the first time, may request the user to consider to make him or her a part of advertisement or promotion list.

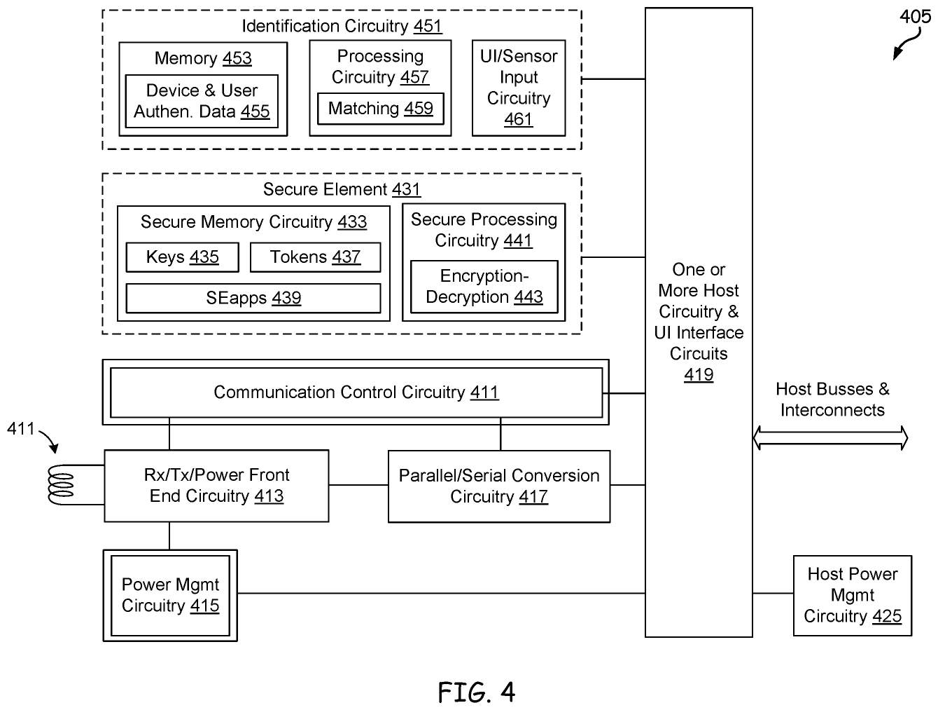

FIG. 4 is a schematic diagram illustrating the user payment device of the FIG. 1, as an example; wherein the user payment device is a near field communication (NFC) device 405. The near field communication device 405, in accordance with the present invention, contains elements of tokenization, cryptograms, ads and promotion support and inductive coupling for making the payments. The near field communication device 405 can be used both online and offline (power down).

To make payments, the near field communication device 405 contains an inductive coupling element 411, a receiver/transmitter/power frontend circuitry 413, parallel to serial (and serial to parallel) conversion circuitry 417 and communication control circuitry 411. The power management circuitry 415 allows the device to couple with an external device, so that it can also be used under power down mode. The receiver/transmitter/power frontend circuitry 413 contains frontend amplifier (to amplify weak radio frequency signals) and downconverter (to convert signals riding on a high frequency carrier to signals, that can be used to make payment transactions and ads and promotions possible).

For example, the near field communication device 405 can be incorporated in a smart phone, tablet or may be used as an independent payment device. Once incorporated, the near field communication device 405 can be used make payments in a grocery chain or any other brick and mortar shops. The near field communication device 405 uses inductive coupling to transfer information between two near field communication enabled devices without contact (that is, the near field communication device 405 can be used as a contactless payment device).

The near field communication device 405 also consists of secure element 431, which in turn consists of secure memory circuitry 433 and secure processing circuitry 441. The secure memory circuitry 433 consists of securely stored keys 435, tokens 437 and secure element applets 439. The secure processing circuitry 411 consists of encryption and decryption circuitry 443. In accordance with the present invention, the secure element 431 makes data (such as primary account number, payment transaction information, and ads and promotions) transfer, in a secured manner, possible.

The near field communication device 405 also consists of identification circuitry 451, which in turn consists of memory 453, processing circuitry 457 and user interface and sensor input circuitry 461. The memory 453 consists of device and user authentication data 455. The processing circuitry 457 consists of matching unit 459. Additionally, the near field communication device 405 consists of host circuitry and UI interface circuitry and host power management circuitry 425.

In accordance with the present invention, the ads and promotions are delivered to the user by utilizing the payment transactions that occurred at the time of payment (along with the history of past payment related payment transactions), via a smart phone or tablet screen. The ads and promotion delivery (from the TCCM infrastructure 111 of FIG. 1), based on the current and past payment transactions, for example, occurs via the same channel as that of the tokenization and encryption. The ads and promotion delivery are done using the same security measures as that of the payments, since these interactions can be highly personalized and may contain data applicable only to the user. For all these, as in the present example, NFC devices are advantageous.

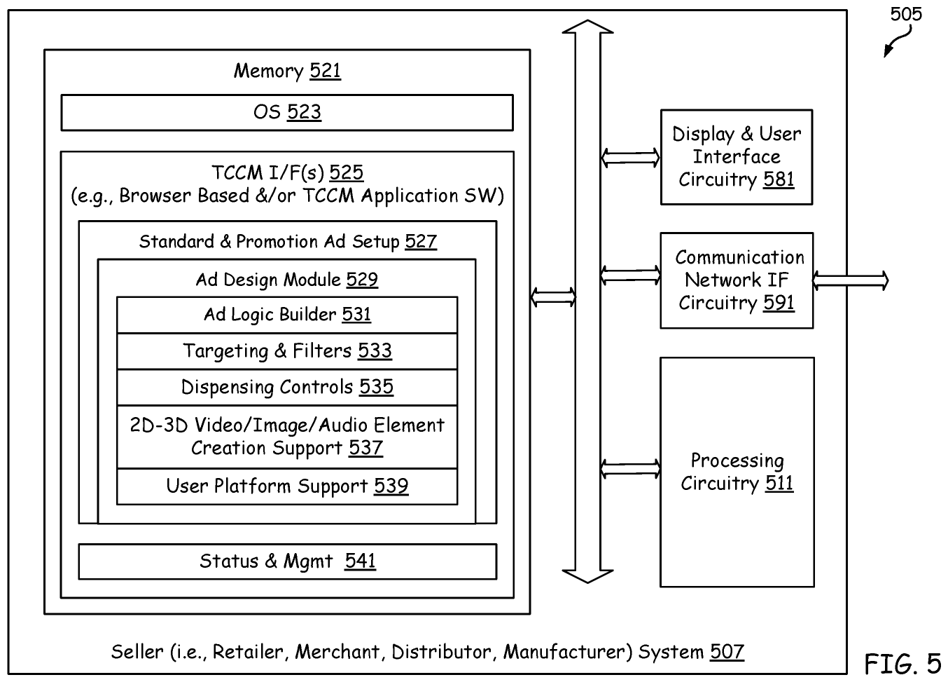

FIG. 5 is a schematic diagram illustrating the seller system 507 or merchant system of FIG. 1, in accordance with the present invention. The seller system 507 can be a manufacturer's system, distributor's system, merchant's system or retailer's system (the infrastructure architecture is the same). The seller system 507 consists of a processing circuitry 511, communication network interface circuitry 591, display and user interface circuitry 581 and memory unit 521. The memory 521 consists of an operating system 523 and TCCM interfaces 525.

The TCCM interfaces 525 can be a standalone TCCM application software running in a standalone computer, computer network, mobile (smart) phone or even be a mini computer system, for example. (Note that the standalone TCCM application software running on a smart phone may be a scaled down version of that runs on the computer system or computer network.) Alternatively, the TCCM interfaces 525 can also be a browser-based application that can run on any computer system or smart phone that contains a built-in browser. In case of smart phones, a mobile friendly version can suit better.

The TCCM interfaces 525 contains standard advertisement and promotion advertisement setup module 527 and status and management module 541. The standard advertisement and promotion advertisement setup module 527 allows the manufacturer, distributor, merchant or retailer (seller, hereon) to setup the advertisements or promotions. For example, the ads or promotions maybe of pre-transaction, mid-transaction or post-transaction, as explained with reference to the FIG. 1. The ads and promotions can also belong to different sectors, such as automobile, gardening, teaching and so forth. The seller can setup all the classifications by choosing via radio buttons or lists, for example.

The standard advertisement and promotion advertisement setup module 527, in turn, contains an advertisements and promotions design module 529. This advertisements and promotions design module 529 allows the seller to design advertisements that can be as simple as text messages, texts embedded in a given background photograph (that represents the seller's products) to full-fledged 2D-3D video/image/audio elements. Alternatively, the seller can also import advertisements and promotions that were created in other platforms (in other standard software).

The ad design module 529 consists of ad logic builder 531, targeting and filters 533, dispensing controls 535, 2D-3D video/image/audio element creation support 537 and user platform support 539.

Targeting and filters 533 allows the seller to target the advertisements and promotions to specific group of people such as students, blue-collared workers, computer engineers, doctors belonging to certain specialization, sports people of some specialization and so forth. For example, the seller may wish to target students and sports people who play tennis, to sell tennis racquets. The targeting and filters 533 allow the seller to build advertisements and promotions that meet such requirements.

The advertisements field is fast developing one and may today include 2D-3D video/image/audio elements, such as virtual reality (VR) and augmented reality (AR). Many new forms of creative advertisements and promotions come into existence every day and to support such diverse fields, the ad design module 529 contains the 2D-3D video/image/audio element creation support 537.

FIG. 6 is a schematic diagram illustrating the TCCM server architecture 607, in accordance with the present invention. The TCCM server architecture 607 comprises of a processing circuitry 693, display and user interface circuitry 681, communication interface circuitry 691, secure cloud elements 695, database infrastructure and linkages 641, memory 621, seller support services 661 and TCCM management hardware and software 671. The TCCM server 607 links to the seller systems of FIG. 6 and the user payment devices of FIG. 3 via a communication networks 619 made up of one or more of Internet, wired or wireless communication networks, and wired or wireless point to point links.

The secure cloud elements module 695 can be a combination of hardware and software elements, they make the tokenization and encryption possible. The tokens and their corresponding PAN are also securely stored in a token vault 653. In cloud-based secure elements, the secure element can be cloud or user's payment device 161 (of FIG. 1) or both. Moreover, public and private key based encryption and decryption (E2EE—End to End Encryption) also utilize the services of secured cloud elements 695. The token2PAN and PAN2token translator 697, by using the token vault database 653, translates token to primary account number, or vice versa, in a highly secured environment.

The memory 621 contains operating system 623 and tokenization setup 625. The tokenization setup 625 allows software or service interactions with the user to occur. The database infrastructure and linkages 641 contains many databases, as relevant to the TCCM server 607, including user info database 645 (which contains databases of user profile 649 and purchase transaction info 651), seller support database 643 (which contains database of seller ads and promotions 647) and the token vault database 653.

The seller support services module 661 consists of seller setup 663 and instant ads, rebates and coupons and rules management module 665. The seller support module 661 services the seller systems (507 of FIG. 5). To perform its functions efficiently and securely, the seller support services module 661 utilizes the seller support database 643, which in turn uses the seller ad database 647.

Further, the TCCM management hardware and software unit 671 manages entire TCCM server 607, contains TCCM interfaces 673.

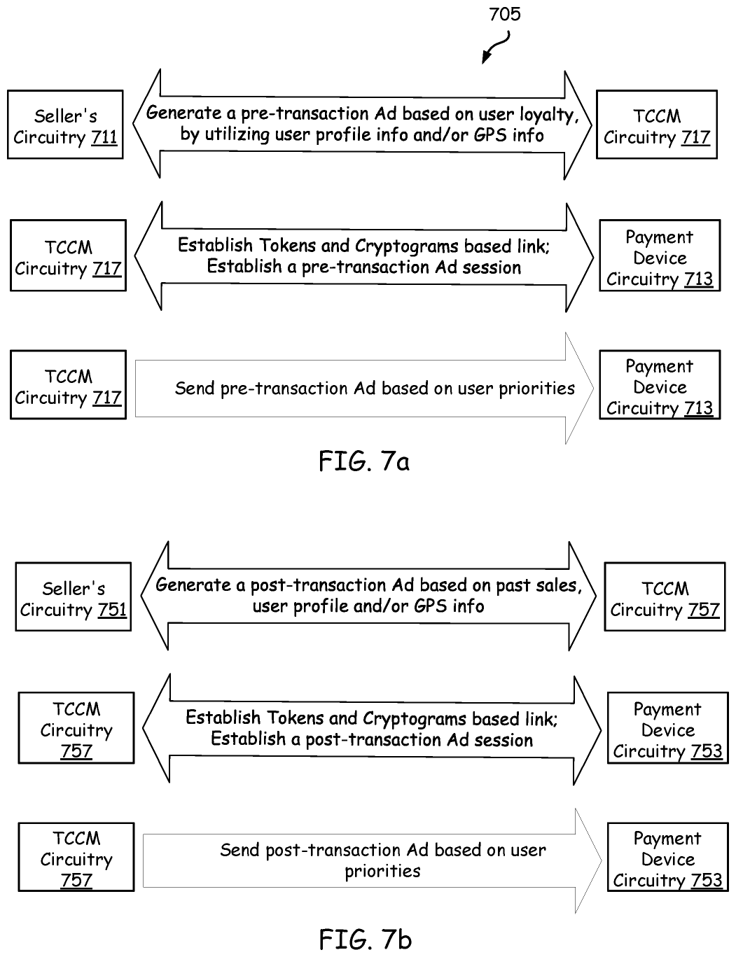

FIG. 7a is a schematic diagram illustrating self-managed advertisements associated with pre-purchase transactions, in accordance with the present invention. The seller's circuitry 711 can be a manufacturer's system, distributor's system, merchant's system or retailer's system.

In general, the TCCM circuitry 717 generates ads and promotions based on the criteria set by the seller. These ads and promotions are conditional, set by various considerations such as loyalty, user profile and GPS information. Once the TCCM circuitry 717 is programmed to generate ads and promotions upon meeting the criteria set by the seller, the TCCM circuitry 717 works all by itself to interact with the user's device 711. The pre-transaction ads involve advertisements and promotions generated based upon past payment transaction history, but before the current transaction is actually taking place, the conditions for which are preprogrammed by the seller.

The process begins by the TCCM circuitry 717 generating a pre-transaction ad (or promotion) based on user loyalty, by utilizing user profile and/or GPS info. This preprogramming is done by the seller's circuitry 711 (the seller), by interacting with the TCCM circuitry 717. Then, at any time (but before the anticipated actual payment transaction takes place) the TCCM circuitry 717 establishes tokens and cryptogram-based link with the payment device circuitry 713, thereby establishing a pre-transaction ad session. Then, the TCCM circuitry 717 sends the ad or promotion thus generated to the payment device circuitry, by considering the user priorities as well.

For example, the user maybe a regular visitor of a grocery shop. The merchant (owner of the grocery store), based on the past transactions, but have not been to the grocery store recently, may decide to send a promotional ad to the user's payment device 713 (such as a mobile phone or tablet). The merchant, to take care of such circumstances, preprograms the TCCM circuitry 717, by creating conditions upon which such promotional ads be sent to the user. For example, if the regular users (loyalty) have not visited the store for more than a month, provide discounts to them (send the promotional ad to the user). Alternatively, if the GPS data shows that the user is nearby, send him or her a promotional ad that provides the user with a discount. However, if the user is out of station during that period, for example, he may as well set his priorities as do not wish to receive any ads or promotions. In that case, TCCM circuitry 717 does not send any promotional ads.

FIG. 7b is a schematic diagram illustrating self-managed advertisements associated with post-purchase transactions, in accordance with the present invention. The seller's circuitry 751 may represent one of a manufacturer, distributor, merchant or retailer.

The TCCM circuitry 757, in this case, generates ads and promotions based on the criteria set by the seller, by considering loyalty, user profile and GPS information etc. The post-transaction ads involve advertisements and promotions generated based on past payment transaction history and sent after the current transaction actually took place, the conditions for which are preprogrammed by the seller.

The processes involve generating a post-transaction ad (or promotion) based on user loyalty, by utilizing user profile and/or GPS info, by the interactions between the seller's circuitry 751 and the TCCM circuitry 757. Then, at any time after payment transaction takes place, the TCCM circuitry 757 establishes tokens and cryptogram-based link with the payment device circuitry 753, thereby establishing a post-transaction ad session. Then, the TCCM circuitry 757 sends the ad or promotion (post-transaction ad based on user priorities) thus generated to the payment device circuitry. This is done in conjunction with the user priorities.

For example, the user may have just bought a washing machine from an electronic store. The seller, based on criteria such as age, gender may have preprogrammed the TCCM circuitry 757 to send post-transaction ad (upon purchasing a washing machine) promoting a four-year warranty. All other considerations, in case of post-transaction ads are similar to that of the pre-transaction ads and promotions.

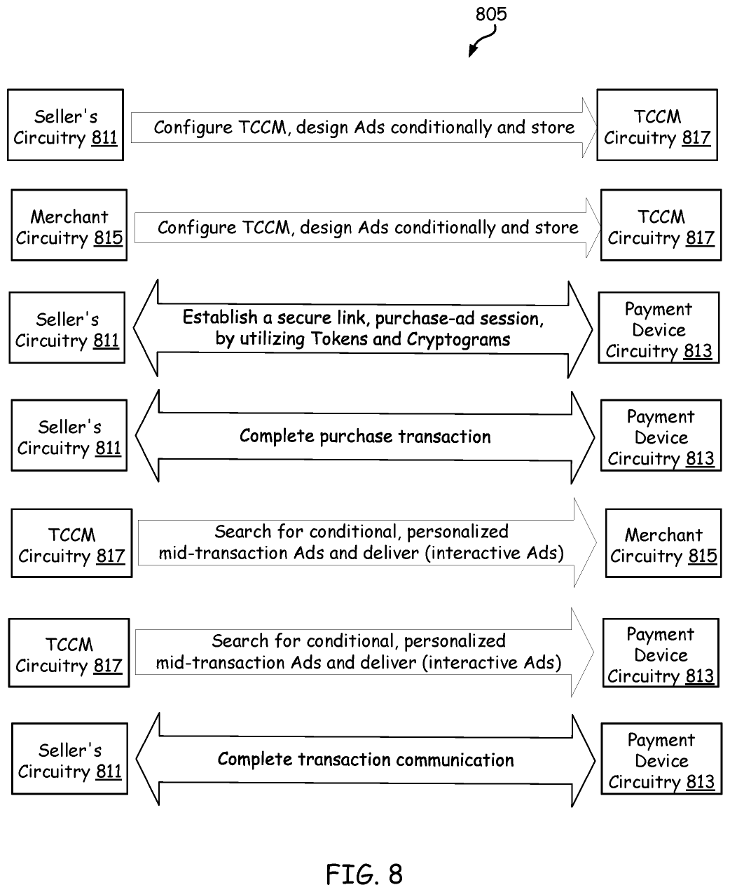

FIG. 8 is a schematic diagram illustrating self-managed advertisements associated with mid-purchase transactions, in accordance with the present invention. The seller's circuitry 811 may also represent that of manufacturer, distributor or retailer.

The process of mid-transaction advertisements and promotions begin with the TCCM circuitry 817 being preprogrammed by the seller or merchant (via seller's circuitry 811 and merchant's circuitry 815, respectively). The preprogramming involves designing ads and promotions conditionally and storing them in the TCCM circuitry 817. The conditions with which the advertisements or promotions are designed may involve targeting a specific group of people (thereby not wasting money on sending advertisements or promotions to the individual users for whom they are not useful or relevant).

Then, the seller's circuitry 811 establishes a secure link (via the channel of tokens and cryptograms) with the payment device circuitry 813 and conducts purchase transactions. That completes the purchase transaction. However, the same session is also kept open for the communications involving mid-transaction advertisements and promotions.

The TCCM circuitry 817 then searches for conditional, personalized mid-transaction ads or promotions and delivers them to the payment device circuitry 813. In another embodiment, the seller being the manufacturer, for example, may deliver similar advertisement or promotion to a merchant. In this case, the TCCM circuitry 817 sends advertisement or promotion to the merchant circuitry 815. Then, the TCCM circuitry 817 completes the purchase ad session.

In another embodiment of the present invention, the purchase transaction may not complete until the advertisement or promotion is delivered to the user. For example, when the user purchases a cup of coffee and pays for it, in a coffee shop chain, the promotion may pop-up as “Would you like to buy doughnut with it as well, at half the regular price?”

In addition, the mid-transaction advertisements and promotions involve sending them during the actual payment transaction takes place. For example, a promotion may involve giving rebate to a product just purchased. For such cases, the TCCM circuitry 817 actually stores the users credit account details in a database. Furthermore, this allows advertisers to push micro-transaction moneys directly to consumers into their credit account databases for ads that they are wanting to see. Also, this allows for more instant wallet payments from Insta and placed self-managed ads to purchases even direct to a seller in a single click.

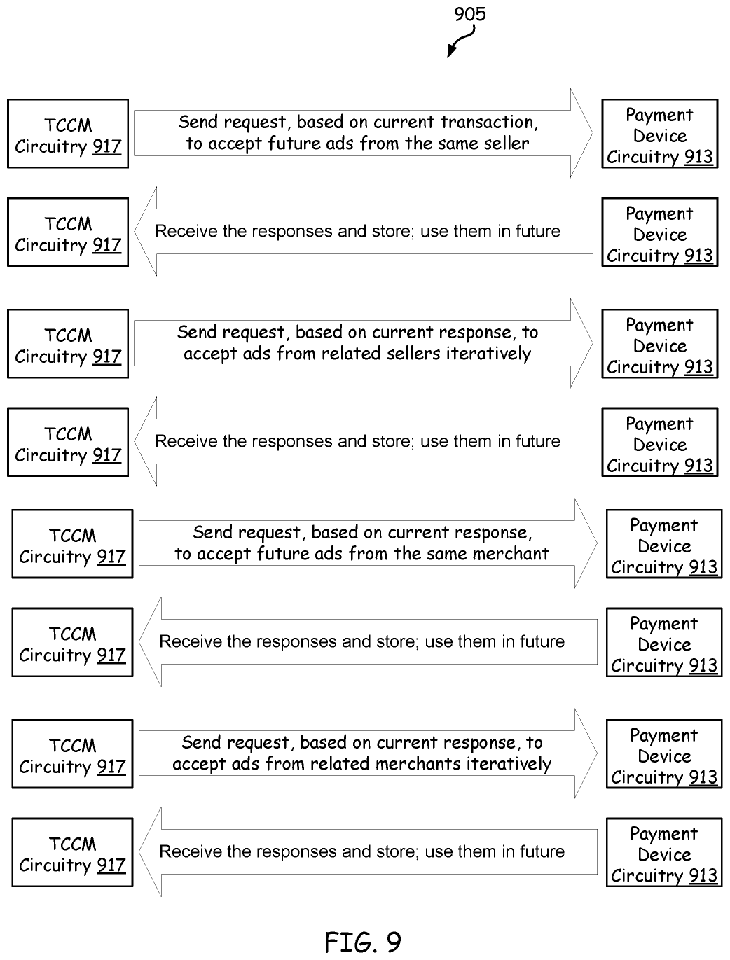

FIG. 9 is a schematic diagram illustrating the processes involved in self-management by the user payment device 913. In specific, the TCCM circuitry 917, based on preprogramming done by a seller or merchant, provides with many options to the user of the payment device circuitry 913. Note that a seller may also be a manufacturer, distributor or retailer.

To begin with, immediately after the payment transaction (when the relationship between the seller and user is new), the TCCM circuitry 917 requests the user payment device 913 to accept the seller. If the user accepts (via the payment device circuitry 913), it begins a new relationship between the seller and user. Then, the TCCM circuitry 917 stores the response from the payment device circuitry 913, along with credit card or wallet details (if the user accepts) and the current payment transaction. Then onwards, the TCCM circuitry 917 keeps all payment transactions as a part of user profile buildup. If the user is willing to continue (regardless of the response), the TCCM circuitry 917 iteratively provides a list of other sellers, from related fields as well. Then, a similar process continues with merchants in consideration.

Further, based on the preprogramming of the TCCM circuitry 917 done by the seller, it sends another request to accept ads and promotions from this seller. This request provides many options to the user of the payment device circuitry 913. These options are provided iteratively (and interactively), so the user can begin to accept advertisements and promotions by a particular seller or merchant, or a group of sellers and merchants. The TCCM circuitry 917 keeps records of all these interactions for the future use.

For example, the process of accepting the sellers or merchants may begin with simple text messages, such as “Would you like to accept the current seller, from whom you bought this product?” Or, a list of sellers maybe provided with, from which, via the payment device circuitry 913, the user may select few or none at all. Similar process involves with the merchants.

In one embodiment, the merchant terminal/merchant systems 181 sends cryptogram data to the TCCM infrastructure 111. The cryptogram is decrypted and processed by the card issuer system also called the account issuer system 151. This could mean that the advertising system 105 is fed transaction data by the card issuer system 151. Alternatively, the phone device 161 send its transaction data directly to the TCCM infrastructure 111. This makes it possible to communicate the transaction data collected during a purchase transaction during or after a transaction is conducted by the phone device 161 according to an app which using Internet communicates the transaction data and receives the advertising data completely outside of the card-based transaction normal flow. In this embodiment, the phone device 161 interacts with the TCCM infrastructure 111 and receives subsequently advertising data completely outside of the card-based transaction normal flow, wherein the card-based transaction normal flow is also necessary to complete the current transaction.

As one of ordinary skill in the art will appreciate, the terms “operably coupled” and “communicatively coupled,” as may be used herein, include direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (i.e., where one element is coupled to another element by inference) includes direct and indirect coupling between two elements in the same manner as “operably coupled” and “communicatively coupled.”

Although the present invention has been described in terms of GPS coordinates/and navigational information communication involving mobile phones and computers, it must be clear that the present invention also applies to other types of devices including mobile devices, laptops with a browser, a hand-held device such as a PDA, a television, a set-top-box, a media center at home, robots, robotic devices, vehicles capable of navigation, and a computer communicatively coupled to the network.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

What is claimed is:

1. A method used by an advertising system associated with a card-based transaction flow, the card-based transaction flow supporting a card issuer via a token management infrastructure, the method comprising:
receiving, during an ongoing purchase transaction, transaction data from a point of sale system of a first merchant, the transaction data comprising purchased product data, merchant identification data, and a token representing a card of a buyer, the transaction data being generated based on the ongoing purchase transaction that is established between the point of sale system and a phone device of the buyer, the phone device having a secure element containing card data corresponding to the card of the buyer;
analyzing, during the ongoing purchase transaction, at least a portion of the transaction data and identifying, based on the analysis, advertisement data, the advertisement data corresponding to at least one offer from one of a plurality of second merchants; and
delivering, during the ongoing purchase transaction, the advertisement data to the phone device of the buyer for presentation to the buyer.

2. The method of claim 1, further comprising receiving and storing the advertisement data in advance of the ongoing purchase transaction.

3. The method of claim 1, wherein the receiving comprises obtaining the transaction data from the card-based transaction flow, the obtaining occurring during an associated ongoing purchase transaction.

4. The method of claim 1, wherein the presentation to the buyer occurs on the phone device during the ongoing purchase transaction.

5. The method of claim 1, wherein the advertisement data comprises an offer at a second premises of the one of the plurality of second merchants.

6. The method of claim 1, wherein the phone device supports management of advertising by the buyer.

7. An advertising system associated with a card-based transaction flow, the card-based transaction flow supporting a card issuer via a token management infrastructure, the advertising system comprising:
an advertising database configured to store a plurality of advertisements of a plurality of other merchants;
communication interface circuitry configured to receive card-based transaction data generated during a purchase transaction between a point of sale system of a merchant and a phone device of a buyer, the phone device of the buyer having a secure element containing card data corresponding to a card of the buyer; and
processing circuitry configured to select from the advertising database one of the plurality of advertisements of one of the plurality of other merchants, the one of the plurality of other merchants operating independently of the merchant, the processing circuitry being configured to direct the one of the plurality of advertisements to the phone device of the buyer for presentation to the buyer during the purchase transaction.

8. The advertising system of claim 7, wherein the one of the plurality of advertisements of the one of the plurality of other merchants comprising an offer for the buyer to visit a second premises to conduct a subsequent purchase transaction for a second item.

9. The advertising system of claim 7, wherein receipt of the card-based transaction data by the communication interface occurs from a transaction communication flow between the merchant system, token management system and card issuer system.

10. The advertising system of claim 7, further comprising a buyer interface configured to allow a buyer to manage their advertising settings.

11. The advertising system of claim 7, further comprising a second communication interface.

12. The advertising system of claim 11, wherein the second communication interface is configured to interact with the phone device during the purchase transaction in a communication pathway that is independent of the merchant system.

13. The advertising system of claim 11, wherein the one of the plurality of advertisements is delivered to the phone device via the second communication interface.

14. An advertising system associated with a card-based transaction flow, the card-based transaction flow supporting a card issuer via both a merchant system located at a first premises and a token management infrastructure, the advertising system comprising:
an advertiser interface configured to receive a plurality of advertising data from a plurality of advertisers, a first portion of the plurality of advertising data corresponding to an advertisement associated with a second premises;
an advertising database configured to store the advertising data;
communication interface circuitry configured to receive transaction data generated during a purchase transaction between the merchant system and a phone device of a buyer, the phone device of the buyer having a secure element containing card data corresponding to a card of the buyer; and
processing circuitry configured to select, based on the transaction data, from the advertising database the first portion of the plurality of advertising data, the processing circuitry being configured to direct selected first portion of the plurality of advertising data to the phone device of the buyer for presentation to the buyer.

15. The advertising system of claim 14, wherein the purchase transaction involves a purchase of a first item from the merchant system of a first merchant, and the advertisement associated with the second premises comprises an offer relating to a second item of a second merchant located at the second premises, and the offer comprising a request for the buyer to visit the second premises to conduct a subsequent purchase transaction for the second item.

16. The advertising system of claim 14, wherein receipt of the transaction data by the communication interface occurs from and during exchange of the transaction data in a transaction flow between the merchant system, token management system and card issuer system.

17. The advertising system of claim 14, further comprising a buyer interface configured to allow a buyer to manage their advertising settings.

18. The advertising system of claim 14, wherein the presentation to the buyer occurs after the purchase transaction has completed.

19. The advertising system of claim 14, wherein the advertising database couples with a token management system.

20. The advertising system of claim 14, further comprising a second communication interface configured to interact with the phone device during the purchase transaction in a communication pathway independent of the merchant system.
